(19) United States
(12) Patent Application Publication
(10) Pub. No.: US 2012/0199482 A1
(43) Pub. Date: Aug. 9, 2012

(54) MANUFACTURE OF NANOPARTICLES USING NANOPORES AND VOLTAGE-DRIVEN ELECTROLYTE FLOW

(75) Inventors: Amit Meller, Brookline, MA (US); Meni Wanunu, Cambridge, MA (US)

(73) Assignee: Trustees of Boston University, Boston, MA (US)

(21) Appl. No.: 13/290,376

(22) Filed: Nov. 7, 2011

Related U.S. Application Data
(63) Continuation of application No. PCT/US2010/034040, filed on May 7, 2010.
(60) Provisional application No. 61/176,197, filed on May 7, 2009.

(51) Int. Cl. C25D 1/12; B82Y 40/00; B82Y 30/00

(52) U.S. Cl. 204/483; 977/774; 977/901

(57) ABSTRACT

Disclosed are methods of manufacturing nanoparticles such as quantum dots at desired nanopore locations in a membrane. The methods disclosed use voltage-driven electrolyte flow to drive the nanoparticle formation.

### REFERENCE TO RELATED APPLICATIONS

This application is a continuation of International Application No. PCT/US2010/034040, filed May 7, 2010, which claims the benefit of priority to U.S. Provisional Application No. 61/176,197, filed May 7, 2009, the entire disclosures of which are hereby incorporated by reference.

### GOVERNMENT SUPPORT

This invention was made with Government Support under Contract No. PHY-0403891 awarded by the National Science Foundation. The Government has certain rights in the invention.

### FIELD OF THE INVENTION

The present invention relates to manufacture of nanoparticles in nanopores using voltage-driven electrolyte flow.

### BACKGROUND OF THE INVENTION

Due to their small dimensions, nanometer-scale materials display a range of unique properties which offer great potential for future technology. Two central problems in nanotechnology realization involve (a) controlled synthesis and (b) integration of nanomaterials into functional devices. Controlled synthesis of nanomaterials, i.e., control over the size and composition, is extremely difficult at the nanometer scale, while integration of nanomaterials into devices is a challenge due to difficulties in the precise positioning of nanomaterials. Thus, there remains a need for better methods of manufacturing nanoparticles with controlled sizes and for manufacturing particles that cam better integrated into devices.

### SUMMARY OF THE INVENTION

The invention is based, in part, on the realization that solid state nanopores can be advantageously used for the fabrication of nanoparticles such as quantum dots with precise control over the nanoparticle size.

In one aspect, the invention provides a method for manufacturing a nanoparticle comprising: (a) providing a solid state nanopore having a first chamber and a second chamber, each chamber comprising an electrolyte solution; (b) adding a first reagent to the first chamber of the nanopore; (c) adding a second reagent to the second chamber of the nanopore; (d) applying a first voltage to the nanopore,

such that the first voltage drives formation of a nanoparticle inside the nanopore, wherein the nanoparticle comprises a cation of the first reagent forming an ionic bond with an anion of the second reagent.

In some embodiments, the method further comprises monitoring the current flow through the nanopore before or during the nanoparticle formation.

In some embodiments a drop in current indicates formation of the nanoparticle.

In some embodiments, the nanoparticle is insoluble in water.

In some embodiments, the nanoparticle is a quantum dot.

In some embodiments, the quantum dot comprises a compound selected from the group consisting of CdS, CdSe, CdTe, PbS, PbSe, ZnS, ZnSe, ZnTe, HgS, HgSe, HgTe, GaN, GaP, GaAs, AlN, InAs, InP, InN, AlAs and SbTe.

In some embodiments, the compound comprises CdS.

In some embodiments, the cation of the first reagent is selected from the group consisting of Cd²⁺, In³⁺, Pb²⁺, Zn²⁺, Hg²⁺, Ga³⁺, Al³⁺ and Sb²⁺.

In some embodiments, the anion of the second reagent is selected from the group consisting of S²⁻, Se²⁻, As³⁻, P³⁻, Te²⁻, N³⁻ and As³⁻.

In some embodiments, the solid state nanopore is chemically modified.

In some embodiments, the solid state nanopore is chemically modified with a thiol group, a silyl group, an amine group, a phosphine group.

In some embodiments, the solid state nanopore is coated with a PEG-silane or a hydrocarbon-containing silane.

In some embodiments, the PEG silane is aminosilane coupled to a PEG-succinimidyl ester.

In some embodiments, the electrolyte is KCl or NaCl.

It is understood that any of the above-described embodiments can be combined with each other. Thus, combinations of any two or more of the above-described embodiments are contemplated.

### BRIEF DESCRIPTION OF THE DRAWINGS

In the Drawings:

FIG. 1.1 illustrates a schematic picture of the nanopore device;

FIGS. 1.2A and 1.2B illustrate two schemes for coating nanopores, the ex situ method and the in situ method, respectively;

FIG. 1.3 illustrates structures of the molecules used for various coatings.

FIG. 2 illustrates XPS spectra of bare SiN films on Si (top), and the same substrates after coating with 1 (middle) and 3+4+5 (bottom);

FIG. 3A illustrates bright-field TEM images of a 10 nm nanopore following cleaning with piranha solution;

FIG. 3B illustrates on the Left: TEM image of a 10 nm nanopore following coating with 3+4+5, and on the Right: TEM image of the same pore after 30 s irradiation under low e-beam dose, during which the organic layer appears to have been removed;

FIG. 4 illustrates a current-time trace (measured at 400 mV) for the in situ coating of a 5 nm nanopore using aminosilane 3 (supporting electrolyte: 0.5 M TBACl, solvent: anhydrous MeOH);

FIG. 5A illustrates current-time traces (measured at 100 mV) for the addition of 2% 6 to the cis chamber of a bare 10 nm (I) and amine-coated 12 nm nanopore (II);

FIG. 5B illustrates normalized change in the ion current (measured at 100 mV, 1 M KCl buffered with 10 mM phosphate to pH 5.8) of 12 nm diameter nanopores coated with aminosilane 3 upon the addition of gluteraldehyde (6) to final concentrations of 0.4% (a), 1% (b), and 2% (c) in the cis-chamber (at t=0);

FIG. 5C in the inset illustrates time constant (τ) fitting results to first-order adsorption kinetics for the different concentrations;

FIGS. 6A-6D illustrate IV curves in 1.0 M KCl for 12 nm pores at indicated pH levels before (A) and after (B) APTMS-coating. (C) and (D) show IV curves at 0.1 M KCl for the same uncoated and coated nanopores; and

FIGS. 7A and B illustrate a side view and a top view, respectively, of zeptoliter reactors for nanodevice fabrication and integration.

### DETAILED DESCRIPTION OF THE INVENTION

As used herein, the recitation of a numerical range for a variable is intended to convey that the invention may be practiced with the variable equal to any of the values within that range. Thus, for a variable which is inherently discrete, the variable can be equal to any integer value within the numerical range, including the end-points of the range. Similarly, for a variable which is inherently continuous, the variable can be equal to any real value within the numerical range, including the end-points of the range. As an example, and without limitation, a variable which is described as having values between 0 and 2 can take the values 0, 1 or 2 if the variable is inherently discrete, and can take the values 0.0, 0.1, 0.01, 0.001, or any other real values ≧0 and ≦2 if the variable is inherently continuous.

As used herein, unless specifically indicated otherwise, the word “or” is used in the inclusive sense of “and/or” and not the exclusive sense of “either/or.”

### 1. Nanopores

Nanopores are small holes (approximately 1-100 nm diameter) in a partition (“membrane”) whose thickness is of similar order. The membrane divides a volume into two separate compartments, each of which may contain different types and/or concentrations of analytes. The pore(s) is the only passage between these two compartments. When electrodes are placed in each compartment and a voltage is applied, an electric field develops across the nanopore. The applied electric field acts as a force on charged molecules and ions inside the nanopore. In the case of nanopore-immobilized molecules (e.g., enzymes), this electric field may also induce structural changes, which may in turn modulate their activity. Therefore, immobilization of proteins, enzymes or other forms of chemical functionalization at the nanopore juncture provides unique possibilities, which could not previously be achieved by immobilization of molecules on planar surfaces.

### 2. Methods of Coating Solid-State Nanopores

Nanopores are extremely sensitive single-molecule sensors. Recently, electron beams have been used to fabricate synthetic nanopores in thin solid-state membranes with sub-nanometer resolution. Two approaches are described for monolayer coating of nanopores by: (1) self-assembly from solution, in which nanopores ˜10 nm diameter can be reproducibly coated, and (2) self-assembly under voltage-driven electrolyte flow, in which 5 nm nanopores can be coated.

Nanopores have emerged in recent years as versatile single-molecule detectors. The sensing principle is based on transient interruptions in the ion-current of an electrolyte, induced by the entry, transport, and exit of a particular analyte from the pore. A distinguishing feature of nanopores is that they can be used to analyze not only small molecules, but also long biopolymers, such as DNA and RNA, with resolution on the order of the nanopore length (several nm). A well-studied system involves the lipid-embedded α-hemolysin (α-HL) protein pore, which can accommodate various types of biopolymers. α-HL has been used extensively to discriminate between DNA and RNA sequences, to study DNA unzipping kinetics, orientation of entry, DNA-protein interactions, and peptide transport.¹ An important outcome of these studies has been the realization that threaded biopolymer dynamics is governed by its interactions with the nanopore walls.² This notion was utilized for the detection of small molecules, metal-ions, and the discrimination of enantiomer drugs, by employing molecular biology methods to modify the α-HL nanopore.³ However, the range of sensing applications using α-HL is limited by its fixed dimensions and the delicate lipid membrane.

To expand the realm of nanopore sensing, synthetic nanopores have recently been introduced using a variety of materials, such as polymers,^{4,5} glass,⁶, and thin solid-state membranes⁷⁻¹⁰ Such nanopores have demonstrated utility for sensing single-stranded^{11,12} and double-stranded^{7,11,13} DNA, ions,¹⁴ macromolecules,¹⁵ and proteins^{16,17}. Nanopores incorporated in thin (˜10 nm) solid-state inorganic membranes are highly promising materials, since the nanopore volume can be reduced to a few nm in all dimensions, on par with biological membrane channels. In addition, the planar geometry permits high-resolution fabrication and characterization using the transmission electron microscope (TEM), as exemplified by sub-nm size control for nanopores down to 1 nm diameters.^{7,8,10,11} Further, the fabrication of high-density nanopore arrays is possible,^{10,18} setting the stage for high-throughput biomolecular analysis, in particular ultra-fast DNA sequencing.

Nanoscale control over the surface properties of nanopores can govern its interactions with various analytes, resulting in “smart” nanopore sensors. Various approaches for nanopore functionalization have been reported, from deposition of metals,¹⁹ oxides^{,20 48,21} to various organic modifications^{16,21,22} However, the resulting nanopore structure often gains significant thickness, and in some cases the morphology is unknown, due to unavailability of imaging methods. In particular, molecular coating of solid-state nanopores approaching the nm scale in all dimensions has not been reported to date. Robust procedures for chemical modification of nanopores of sizes 5-20 nm fabricated in thin SiN membranes are provided. Self-assembly methods are employed to control the chemical and physical properties of a single nanopore, such as its charge, polarity, pH sensitivity, etc. Reproducible coating of nanopores as small as 5 nm are described that demonstrate surface modification, fast reaction kinetics, and pH responsiveness. These methods broadly expand the utility of nanopores for biological sensing. Dressing an inorganic pore surface with a variety of organic coatings not only makes it more biologically friendly, but further allows control of surface charge, hydrophobicity, and chemical functionality. An ultra-sensitive single nanopore pH sensor operating at physiological ionic strengths is described.

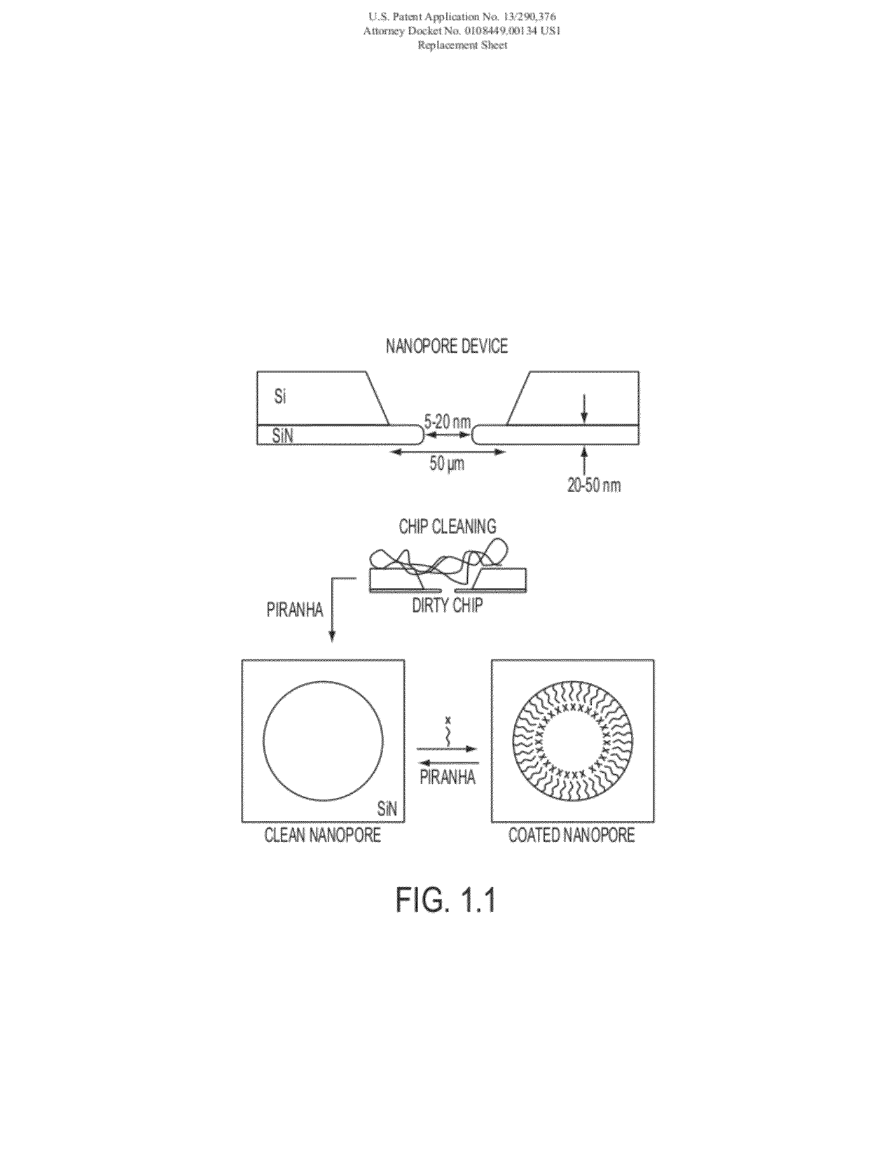

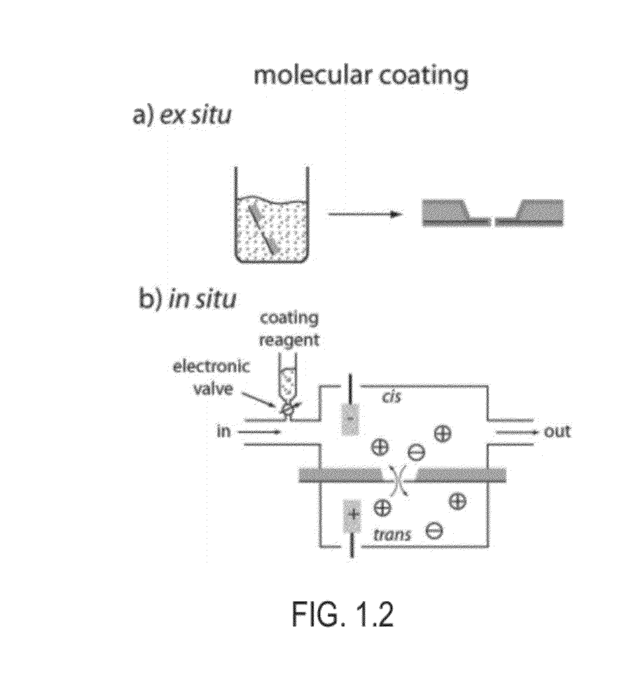

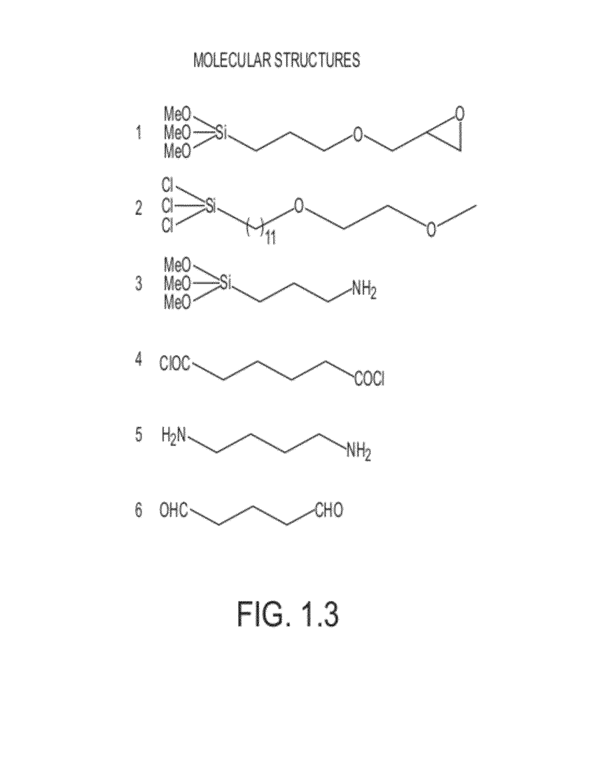

An exemplary solid-state nanopore device is depicted in FIG. 1.1 (left panel) which provides schematic picture of the nanopore device. Piranha solution is used to clean the nanopore surfaces before coating with organosilanes, as well as to “uncoat” the nanopores. FIG. 1.2 (middle panel) shows a depiction of two schemes for coating nanopores. In the ex situ method, the activated nanopore is simply immersed in silane solution, followed by cleaning steps (not shown). In the in situ method, the nanopore device is assembled in a two-chamber cell and a voltage is applied across it, driving supporting electrolyte through the pore during the silane deposition process. FIG. 1.3 (right panel) shows structures of the molecules used for various coatings. Molecules 1-3 are organosilanes, while 4-6 are used in further reactions with functional silane monolayers.

The SiN membrane surface contains a native oxide layer,²³ which is used here for monolayer self-assembly of organosilanes.²⁴ Prior to coating, piranha treatment is used for removal of contaminants and surface activation. Further, the coating procedures are reversible: piranha treatment can be used to completely remove the organic coatings and regenerate the clean nanopore surface. The middle panel, FIG. 1.2, shows two alternative molecular coating approaches: (a) Ex situ assembly, in which the organic coating is performed by immersion of the nanopore chip into the deposition solution. (b) In situ assembly, in which organic molecules are allowed to react with the nanopore surface under driven electrolyte flow. While the ex situ coating method is more straightforward, the in situ method provides additional advantages. For example, the in situ assembly is capable of coating smaller nanopores without clogging, down to 5 nm. On the right panel, FIG. 1.3, the molecules used for coating the nanopores are shown. Films designated with a “+” sign were prepared by multiple reaction steps. Coatings with common functional groups were investigated: Epoxy (1), methoxyethylene glycol (“PEG”-type) (2), amine (3, 3+5), carboxylic acid (3+4), and aldehyde (6). Molecules 1-3 are organosilanes, which directly self-assemble on the nanopore surface to form functional monolayers. Molecules 4 and 6 were used to convert amine-coated surfaces to carboxylic acid and aldehydes, respectively. Molecule 5 was used in further reaction with the 3+4 surface to generate a thicker amine coating (see Supporting Information).

Film thickness, roughness and chemical composition of the different films on planar SiN substrates were investigated by ellipsometry, non-contact atomic force microscopy (AFM) and X-ray photoelectron spectroscopy (XPS). In Table 1, the ellipsometric thickness is compared, 8, with the calculated thickness based on molecular models. Measured thicknesses are in agreement with calculated values for films 1-3, indicating the formation of homogeneous monolayers on the SiN substrate. Moreover, the increase in film thickness upon the addition of 4 or 6 suggests that the amine group remains reactive on the surface. Further, reaction of the terminal carbonyl chloride 3+4 with diamine 5 was successful. AFM characterization on these films yielded RMS roughness values in the range 0.4-0.7 nm, similar to uncoated SiN (0.58 nm), implying a homogeneous film distribution.

TABLE 1
Characterization of the molecular films on
SiN substrates using ellipsometry.

| | Ellipsometry | | |
|---|---|---|---|
| | n_{f}^{†} | δ | Model thickness^{‡} |
| Film | @633 nm | (nm) | (nm) |
| 1 | 1.43 | 1.4 ± 0.1 | 1.1 |
| 2 | 1.46 | 2.5 ± 0.2 | 2.2 |
| 3 | 1.50 | 0.6 ± 0.1 | 0.7 |
| 3 + 4 | 1.50 | 1.2 ± 0.2 | 1.4 |
| 3 + 4 + 5 | 1.50 | 1.7 ± 0.2 | 2.1 |
| 3 + 6 | 1.50 | 1.1 ± 0.2 | 1.3 |

^{†}Based on bulk refractive index values.
^{‡}Calculated from molecular models (CS Chem3D), assuming upright orientation on the surface.

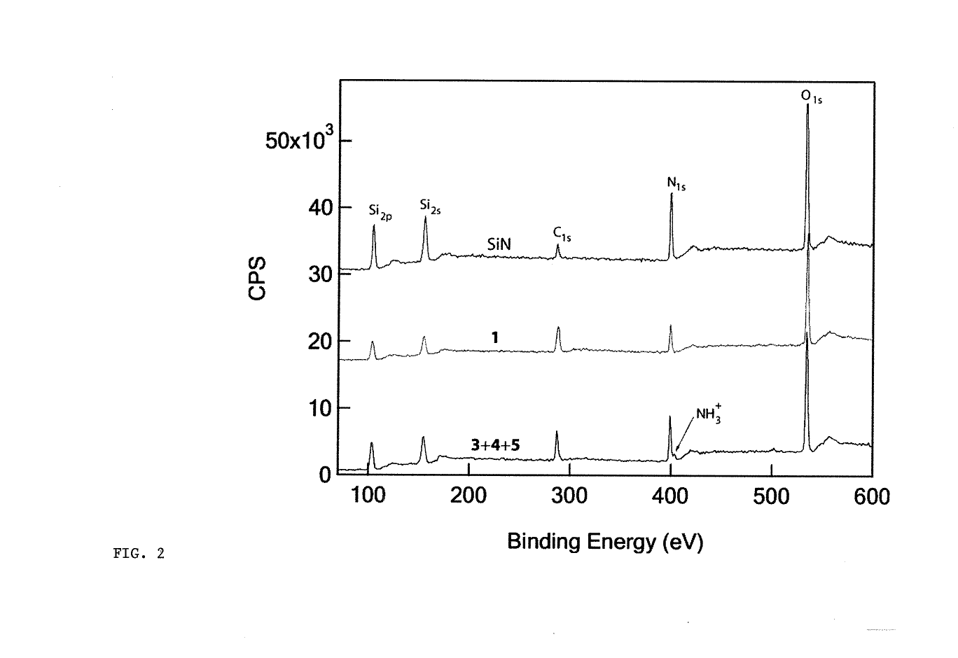

XPS measurements were performed to validate the chemical identity of the coated films. FIG. 2 shows XPS spectra of bare (piranha-treated) SiN films on Si (top), and the same substrates after coating with 1 (middle) and 3+4+5 (bottom). The SiN exhibits strong signals for Si, N, and O, as well as a residual C signal, attributed to contamination. Following coating with 1 (middle curve), the reduction of signals for Si, O, and N is observed, coupled with an increase of the C signal.²⁵ The amino-terminated film (3+4+5) exhibits a second N peak at 402 eV (see arrow), corresponding to a protonated amine state on the film (NH₃⁺).²⁶ A peak at 402 eV is attributed to the presence of ammonium ions in the film 3+4+5. The middle and the top curves were shifted by 15·10³ cps and 30·10³ cps respectively.

TABLE 2
Ion-conductance at 1M KCl, pH 8.5, for bare and coated nanopores
(n = number of trials).

| Coating | D_{bare} (nm) | G_{bare} (nS) | G_{coated} (nS) | <d_{eff}> (nm)^{†} | d′ (nm)^{‡} |
|---|---|---|---|---|---|
| 1 | 13 (n = 2) | 75 ± 4 | 35 ± 4 | 9.5 | 10 |
| | 10 (n = 5) | 34 ± 4 | 20 ± 5 | 7 | 7 |
| 2 | 15 (n = 2) | 120 ± 5 | 26 ± 3 | 9 | 10 |
| | 10 (n = 2) | 34 ± 4 | 13 ± 4 | 6 | 6 |
| 3 | 14 (n = 2) | 100 ± 5 | 55 ± 8 | 12 | 12.5 |
| | 12 (n = 10) | 65 ± 4 | 45 ± 5 | 11 | 10.5 |
| 3 + 4 + | 25 (n = 1) | 250 | 110 | 18 | 21 |
| 5 | 10 (n = 1) | 31 | 9 | 5 | 6 |
| 3 + 6 | 12 (n = 10) | 65 ± 4 | 29 ± 7 | 9 | 9.5 |
| | 10 (n = 1) | 33 | 8 | 5 | 7.5 |

^{†}Average error in all values is ±10%.
^{‡}Based on the ellipsometric thickness (see text).

The coating of highly concave surfaces in confined volume is considerably different than coating of flat surfaces described above. Not only do the concave surfaces induce a different molecular packing, the highly confined volume of the nanopore may alter the adsorption kinetics. Furthermore, the characterization techniques described above cannot be used to probe coating inside a nanopore. On the other hand, the ion flux through the nanopores should be extremely sensitive to the nanopore coating thickness, since the ionic conductance (G) depends quadratically, to a first approximation, on the pore diameter, d. To validate this, an extensive series of ion-conductance measurements were performed for uncoated and coated pores using nanopores with diameters in the range 10-25 nm (Table 2). G was measured for each chip before and after the coating procedure and estimated the effective diameter, d_{eff}, based on the G values. These numbers were compared with the model coated nanopore size, d′=d_{bare}−2δ, where d_{bare} is the TEM measured diameter of the uncoated pore, and 8 is the coating thickness measured by ellipsometry. An agreement between d_{eff} and d′ would indicate that nanopore coating thickness is commensurate with surface coating thickness. As seen in Table 2, the effective nanopore sizes agree very well with the model size for all the coating types used herein, supporting the formation of monolayers with the expected thickness inside the nanopores. A reduction in G may also be attributed to an increase of the membrane thickness. However, only a negligible contribution is expected from this: on the 50 nm thick SiN membrane used in these measurements, the thickest coating (2.5 nm) should increase the membrane thickness by 10% (5 nm), and in turn should decrease G by 10% or less. In contrast, a roughly 80% decrease in G for this coating was observed, implying that the reduction in G is primarily due to coating inside the nanopore.

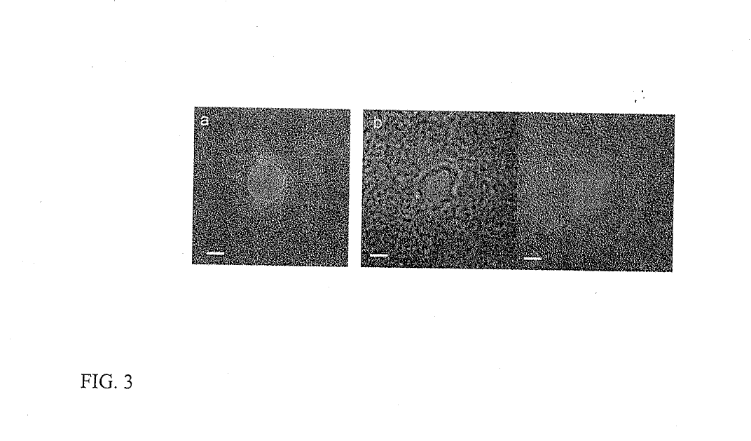

Nanopore coating is further supported by high resolution TEM imaging. FIG. 3a illustrates a bright-field TEM images of a 10 nm nanopore following cleaning with piranha solution. FIG. 3b illustrates on the left: a TEM image of a 10 nm nanopore following coating with 3+4+5. FIG. 3b illustrates on the right: a TEM image of the same pore after 30 s irradiation under low e-beam dose, during which the organic layer appears to have been removed. The scale bar in all images is 5 nm.

FIG. 3b displays a similar 10 nm pore after coating with the 1.7 nm thick 3+4+5 layer. Several marked differences are noted: First, the coated surface displays larger grains. Second, the nanopore boundary appears dull, as opposed to the sharp SiN/pore boundary in the unmodified nanopore. The nanopore interior in the TEM image reveals an uneven grayish decoration (indicated by an arrow), attributed to coating. This layer is clearly in focus, marked by the sharp boundary between the coating and vacuum. The maximum estimated coating thickness is ˜2 nm, very close to the measured coating thickness (1.7 nm). The image on the right in FIG. 3b displays a TEM image of the nanopore following a 30-second exposure to the e-beam under imaging conditions (e-beam intensity: ˜10³ e/nm²s). Clearly, the surface graininess disappeared—highly resembling the uncoated membrane in FIG. 3a. This is in line with destruction of the organic film. The possibility that these changes are caused by changes to the SiN membrane was excluded, since nanopores in SiN are fabricated using a highly focused electron beam of intensity ˜10⁹ e/nm²s, and their final size shaped with an intensity of 10⁶ e/nm²s.^{8,10} Under imaging intensities (<10³ e/nm²s), it has not been⁸ possible to observe changes in nanopore structure over extended imaging periods (minutes). In contrast, low intensity e-beams are known to destroy thin organic films.²⁷

While the ex situ coating procedure is highly reliable for nanopores larger than ˜10 nm, it was found that smaller pores tend to clog, possibly due to accumulation of silane molecules inside the pore. To circumvent this problem, an in situ coating method was introduced (FIG. 1.2b). In this approach, the silane was mixed with organic electrolyte in anhydrous solvent, and a voltage applied across the nanopore during the deposition process. The electric field induces flow of electrolyte across the nanopore, which effectively slows down the molecular adsorption kinetics. This technique is illustrated in FIG. 4, in which the coating of a 5 nm pore with aminosilane 3 is monitored over time. FIG. 4 illustrates a current-time trace (measured at 400 mV) for the in situ coating of a 5 nm nanopore using aminosilane 3 (supporting electrolyte: 0.5 M TBACl, solvent: anhydrous MeOH). Equal aliquots of 3 were injected at points 1 and 2. An anhydrous MeOH was used as the solvent and 0.5 M tetrabutylammonium chloride (TBACl) as the supporting electrolyte. The injection of 3 at 50 s, (arrow 1) resulted in a nearly exponential decrease in the current from 1.2 nA down to ˜0.7 nA, with a characteristic time scale of 17 s. The addition of an equal aliquot of 3 at 600 s (arrow 2) caused only a minor decrease in the current, from 0.7 nA to ˜0.6 nA. The first aliquot of 3 resulted in monolayer deposition on the pore surface. Based on the molecular thickness of 3 (0.7 nm, see Table 1), a single monolayer decreases the pore cross-sectional area by 48%. This value is in excellent agreement with the measured reduction in current of 42%. The minor additional decrease in the current after the second addition of 3 is attributed to dilution of the electrolyte by the uncharged silane. Similar results were obtained in repeated measurements.

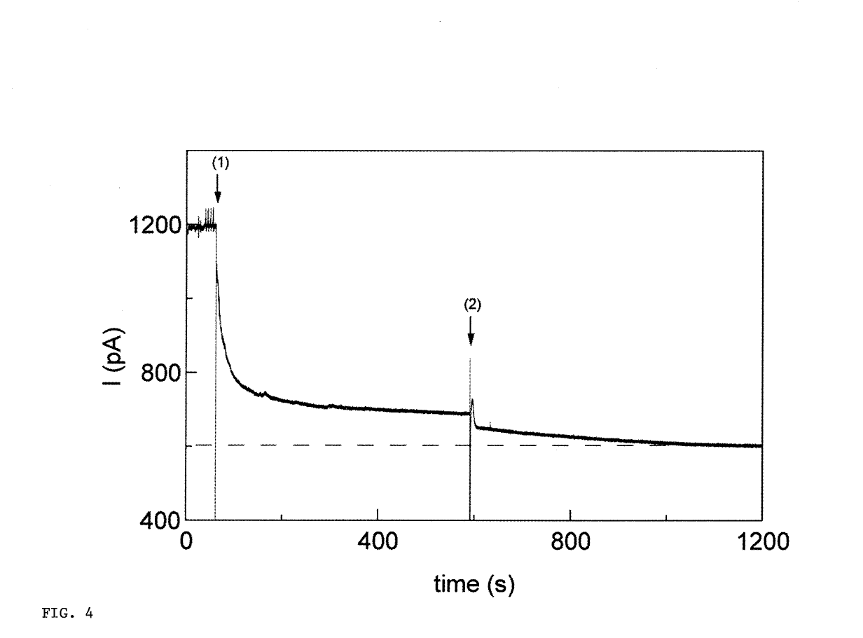

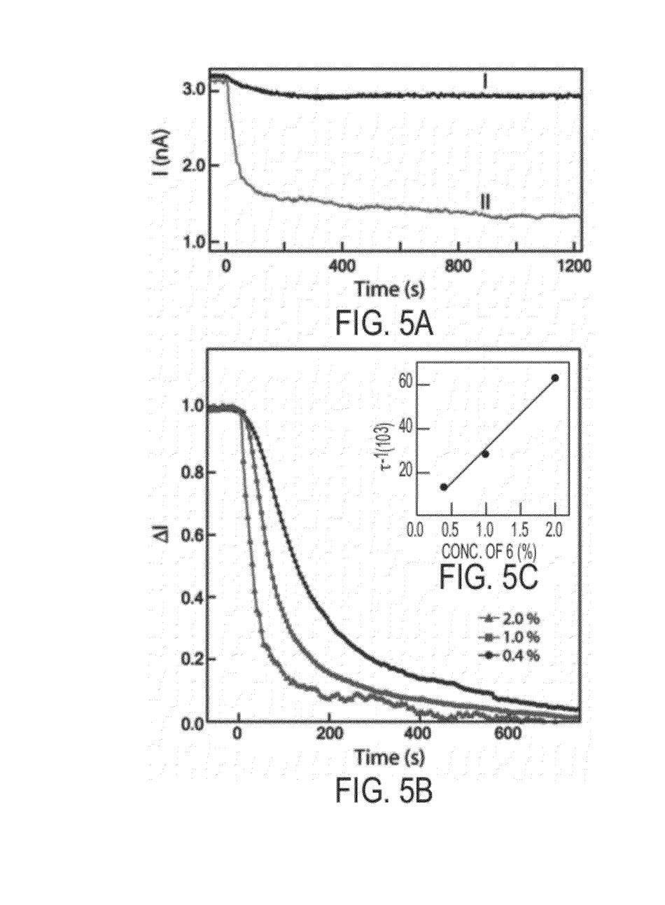

FIG. 5a illustrates current-time traces (measured at 100 mV) for the addition of 2% 6 to the cis chamber of a bare 10 nm (I) and amine-coated 12 nm nanopore (II). FIG. 5b illustrates normalized change in the ion current (measured at 100 mV, 1 M KCl buffered with 10 mM phosphate to pH 5.8) of 12 nm diameter nanopores coated with aminosilane 3 upon the addition of gluteraldehyde (6) to final concentrations of 0.4% (a), 1% (b), and 2% (c) in the cis-chamber (at t=0). The bulk conductivities of the GA solutions were adjusted in order to match that of the electrolyte (161±1 mS). The inset, FIG. 5c, illustrates time constant (τ) fitting results to first-order adsorption kinetics for the different concentrations. The solid line is a best fit to the data.

Amine-modified surfaces are versatile platforms for a wide range of applications in biotechnology. For example, glutaraldehyde (6) is a common reagent used for coupling amine-modified surfaces with proteins.²⁸ Coated nanopore functionality was tested by monitoring the reaction of amine-coated nanopores with glutaraldehyde. FIG. 5a displays an ion current trace (measured in 1M KCl aqueous solution, pH 5.8) of a 12 nm nanopore pre-coated with aminosilane 3. Upon the addition of 6 at t=0 (to a final concentration of 2%), G quickly drops by ˜50% and stabilizes at a level of ˜1.5 nA (II). To show that the current reduction is specifically due to reaction with the amine-coated nanopore, a current trace measured during the addition of 2% of compound 6 to an uncoated 10 nm pore (I), which resulted in only 6% change in G is displayed. This illustrates the specificity of the glutaraldehyde reaction on amine coated pores.

The reaction kinetics inside an amine-coated nanopore also shows dependence on the bulk concentration of 6. In FIG. 5b, three ion-current traces obtained during addition of 6 at bulk concentrations of 2.0%, 1.0% and 0.4% v/v are presented. These curves were fitted to first-order adsorption kinetics, yielding a linear dependence on concentration (FIG. 5c, inset). In all cases, the steady state ion-current levels after the addition of 6 were 50±10% of the initial pore currents.

Aside from the bulk concentration of ions, surface charges may also affect ion-transport through nanoscale channels.^{29,30} To investigate this effect in nanopores, the fact that amino groups can be protonated upon lowering the solution pH is used. Since surface ammonium pKₐ values are lower (pKₐ-5-6) than in solution (pKₐ˜9),³¹ a strong ion conductance pH dependence around pH 5-6 is expected be observed.

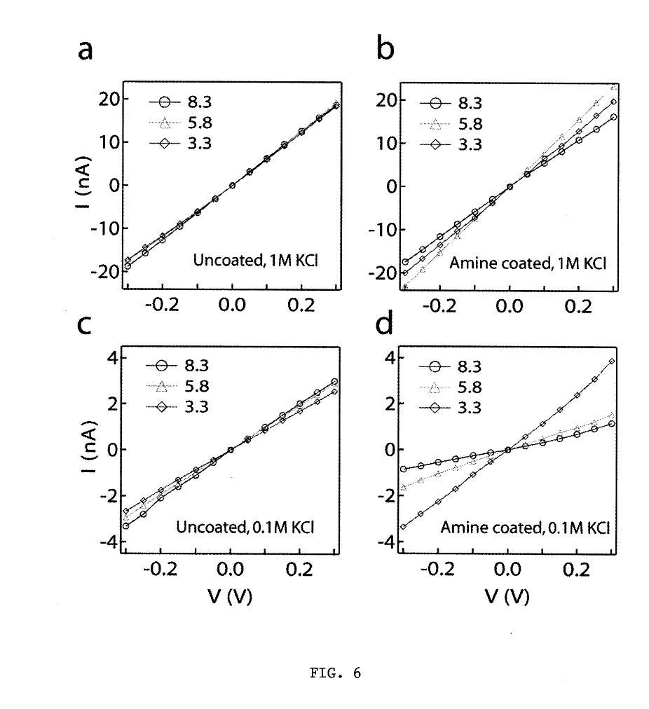

In FIG. 6, I-V curves of an 12 nm uncoated nanopore (a), and an amine-coated nanopore (after APTMS-coating) (b), at 1.0 M KCl, at pH 3.3, 5.8 and 8.3 are presented. FIGS. 6(c) and (d) show IV curves for similar measurements at 0.1 M KCl for the same uncoated and coated nanopores. The coated pore conductance shows high pH sensitivity at the low ionic strength level. At 1M KCl, both coated and uncoated pores exhibit a weak pH dependence on conductance. In contrast, the coated pore displays a marked current enhancement (−4 fold), going from pH 8.3 down to pH 3.3, while the uncoated pore remains insensitive to pH even at the low ionic strength. To explain the marked pH sensitivity of the coated pores the pore current is written as:

$$I \approx \frac{π {d}^{2}}{4} {σ}_{B} ( 1 + 4 \frac{{λ}_{D}}{d} ɛ ) , \qquad ( 1 )$$

where σ_{B} is the bulk mobilities of the KCl ions, λ_{D} the Debye length (effective double-layer thickness), and

$$ɛ = \frac{{σ}_{S} - {σ}_{B}}{{σ}_{B}}$$

is the mobility enhancement (or reduction) near the surface. At 1M KCl, λ_{D} is roughly 0.3 nm, thus

$$\frac{{λ}_{D}}{d} ≪ 1$$

and surface effects are small. On the other hand, at 0.1M KCl, λ_{D}˜1 nm, thus

$$\frac{{λ}_{D}}{d} ∼ 0.1 ,$$

leading to a significant pH dependence on the ion-conductance. The results are in agreement with measurements performed in track-etched PETP pores, which have native carboxylic groups on their surface.⁴ In the same range of pH values, Stein and co-workers have observed ˜60% enhancement in the conductance for amine-modified channels etched in glass.²⁹ Herein, the channel width was ˜400 nm, roughly two orders of magnitudes larger than the nanopores herein. According to Eq. 1, in order to observe a similar current enhancement, the required ionic strength would be ˜4 orders of magnitude smaller (λ_{D}˜I^{-1/2}, where I is the ionic strength) than in the described experiment, or roughly 10⁻⁵M. This value is indeed close to the molar concentration used in reference 29, for which measurable pH effects were observed.

Ex situ and in situ methods for nanopore functionalization using self-assembly of organosilane molecules were presented. A number of analytical methods have been employed to clearly demonstrate: A) monolayer coating of various chemical groups inside >10 nm pores fabricated in SiN membranes. B) Ion-current through the coated nanopores closely correlates with the coating thickness. In situ measurements were used to probe the coating kinetics in real time. Due to their wide range of applicability, on amine terminated groups were focused on. It is shown that second, selective layer, can be formed on amine-coated pores, and that the adsorption kinetics can be observed by monitoring the ion-current flowing through single nanopores. It is noted that the characteristic adsorption timescale is comparable with bulk adsorption onto planar surfaces, suggesting high reactivity on the nanopore surface.

The coated nanopore is stable over days, even under treatments with voltage pulses of up to 5 V. This result is encouraging, considering the fact that silane monolayers can degrade under in vitro solution conditions.³² Amine-coated nanopores exhibit pH sensitive conductance, similar to previously reported effects. However, due to the small dimensions of instant nanopores, a 4-fold difference in the conductance at physiological ionic strengths (0.1 M) was observed. Coated nanoscale pores can thus be used to fabricate ultra small and sensitive pH sensors. Chemically-modified nanopores fabricated in inorganic membranes open a wide range of possibilities for stochastic sensing. For example, amine-terminated groups can be used to immobilize protein receptors in a robust, nearly two-dimensional device. The planar geometry allows straightforward multiplexing using nanopore arrays. The chemically-modified nanopores can be used to gate single-molecule transport.

### 3. Coating Chemically-Modified Solid-State Nanopores

Detailed experimental protocols are provided for the coating of solid state nanopores are provided below.

(1) Chemicals. Toluene (Burdick & Jackson, A R) was dried by distillation from CaH₂ and storage over activated 4 Å molecular sieves. MeOH, CHCl₃, and CH₃CN (anhydrous, Baker) were used as received. Glycidyloxypropyltrimethoxysilane (1, Alfa-Aesar, 97%), methoxyethoxyundecyltrichlorosilane (2, Gelest, Inc., 95%), 3-aminopropyltrimethoxysilane (3, Acros, 95%), adipoyl chloride (4, 97%, Alfa Aesar), 1,4-diaminobutane (5, Alfa Aesar, 99%), glutaraldehyde (6, 25% in water, Acros), and all other common reagents were used as received.

(2) Solid-state nanopores. Low-stress SiN membranes (50×50 μm², either 20 or 50 nm thick) were purchased from Protochips Inc. (Raleigh, N.C.). Nanopore fabrication was carried out on the membranes using a JEOL 2010F field emission TEM operating at 200 kV, which was also used for imaging the nanopores. A detailed description of the nanopore fabrication process is given elsewhere.¹⁰

(3) Ex situ nanopore coating. Before coating, nanopore chips were first cleaned by boiling in piranha solution (1:3 H₂O₂:H₂SO₄) for 15 minutes, followed by rinsing in 18 MS2 water, filtered MeOH, and drying at 100° C. for 5 min. Coating with 1 was performed by immersion of the clean chip into 0.1% 1 in toluene for 1 h, followed by agitation in fresh toluene (8×3 ml) for 10 min, drying under N₂ and baking at 100° C. for 1 h. Coating with 2 was performed by immersion into a 2 mM solution of 2 in toluene for 20 min, followed by agitation in fresh toluene (8×3 ml) for 10 min, washing with MeOH, water, and drying under N₂. Coating with 3 was performed by immersion into a 5% solution of 3 in MeOH for 3-6 hours, followed by 10-15 min agitation in MeOH (8×3 ml), drying under N₂, and baking at 100° C. for 30 min. Reaction of the aminosilanized chip with 4 was performed by immersion in a 5% solution of 4 in anhydrous toluene under N₂ for 30 min, followed by agitation in fresh toluene 8 times and drying under N₂. Subsequent reaction with 5 was performed by immersion into a 1% solution of 5 in 1:1 CHCl₃:CH₃CN for 2 h, rinsing with MeOH (8×3 ml), water, and drying under N₂.

(4) Coating characterization. The different coatings were characterized on Si substrates onto which 50 nm low-stress SiN layer was deposited by LPCVD. An ES-1 (V-VASE32) Woollam spectroscopic ellipsometer was used to characterize the film thickness. AFM was performed using Veeco Instruments Multimode operating in the tapping mode. All measurements were performed using the same 10 nm tip with a cantilever frequency of 250 kHz. A SSX-100 Surface Science XPS instrument equipped with a Monochromatic Al-kα source was used for analyzing the films. A spot size of 0.6 mm was used, the takeoff angle was 45±10°, and the chamber pressure was 10⁻⁹-10⁻¹⁰ torr.

(5) Ion-conductance measurements. The ion-conductance of nanopores was checked by mounting the chip in a two-chamber cell such that both sides of the nanopore are separated. In order to wet the nanopore, the chip was wet on the cis side with ca. 5 μl MeOH, filled from the trans side with degassed electrolyte, and then the MeOH was gradually diluted from the cis chamber by flushing with electrolyte. Two Ag/AgCl electrodes were inserted into each chamber, and the leads were connected to an Axopatch 200B amplifier. I-V curves were then recorded at intervals of 50 mV and the conductance calculated from the slope of the curve.

For pH conductance measurements, solutions of different pH values were prepared using 10 mM phosphate buffer, and the bulk conductivities of all solutions at a given ionic strength were adjusted (using a conductivity probe) to within 0.5% by the addition of KCl.

In situ nanopore coating. Silanization of nanopores with 3 was performed by filling both chambers of a clean, 5 nm nanopore, with 0.5M TBACl in anhydrous MeOH. The current was recorded at 400 mV with 100 Hz sampling rate. 5 μl aliquots of 3 were added to ˜150 μl in the cis chamber. In situ reaction of amino-terminated nanopores with glutaraldehyde 6 was performed by mounting nanopores coated with 3 in a nanopore setup and filling the chambers with 1 M KCl, buffered with 10 mM phosphate to pH 5.8. A flow cell was used to introduce different concentrations of 6 to the cis chamber. To avoid conductance changes due to electrolyte dilution, the conductivity of solutions containing 6 were adjusted with KCl to match that of the electrolyte in the chambers.

### 4. Manufacture of Nanoparticles Voltage-Driven Electrolyte Flow

Controlled synthesis of nanomaterials, i.e., control over the size and composition, is extremely difficult at the nanometer scale, while integration of nanomaterials into devices is a challenge due to difficulties in the precise positioning of nanomaterials.

Described is a method for accomplishing controlled synthesis and positioning of nanoparticles using nanopores and nanopore arrays. In some embodiments, the nanopores are chemically-coated. Nanomaterials (e.g., nanoparticles) are usually synthesized by mixing two components in a controlled medium (i.e., stabilizers). The stabilizers protect each nanoparticle in solution from coagulating with other particles. Typically, stabilizers are compounds with long chain hydrocarbon tails. Examples of stabilizers include, but are not limited to a variety of alkanethiols, alkylamines, alkylphosphines and the like. Single nanoparticles can be synthesized and stabilized inside chemically-modified nanopores by mixing two components, each in a different compartment, at the nanopore. The chemically-modified nanopores therefore act as localized reactors for the synthesis and immobilization of nanomaterials, while the coating immobilizes the nanoparticle in the nanopore.

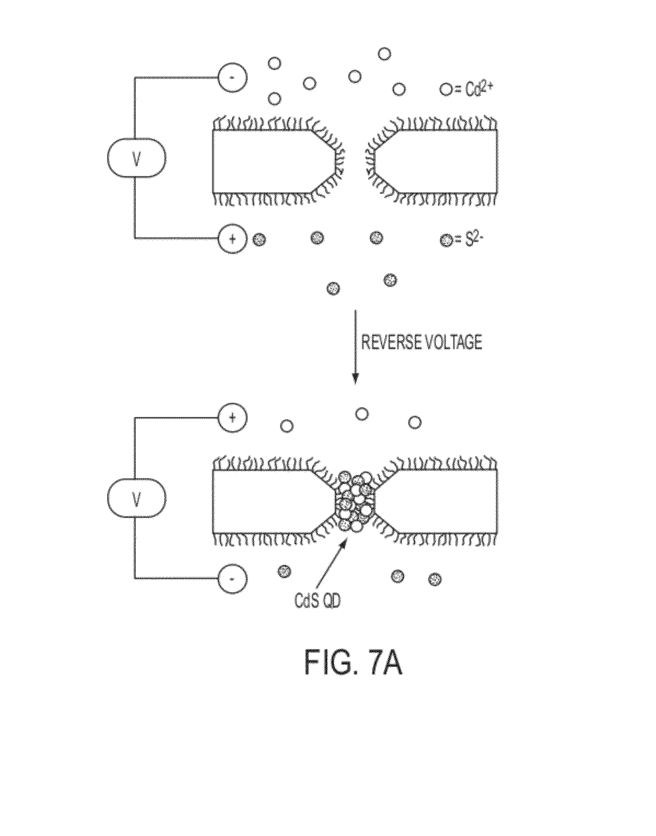

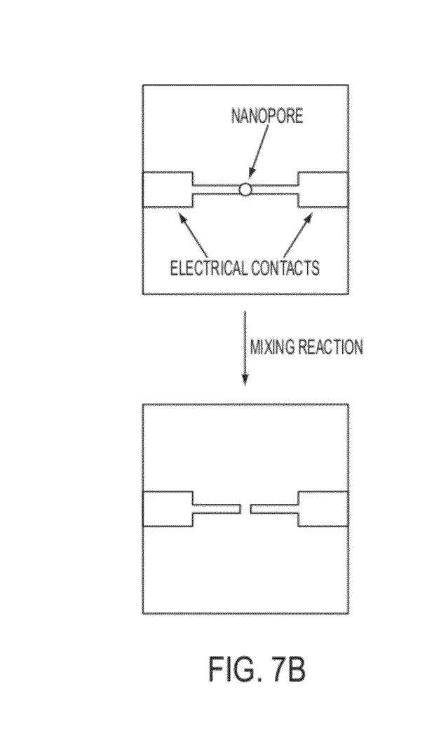

Finally, this procedure is attractive because positioning of the nanomaterials in integrated planar devices (e.g., at the junction between two electrodes) is done by fabricating the nanopores at desired locations on the membrane. Further advantages are: (a) the mixing rate of the ions at the nanopore can be controlled by modulating the voltage across the nanopore; and (b) the progress of the synthesis can be conveniently monitored by measuring the ion-current through the nanopore. This is illustrated in FIGS. 7A and B.

FIGS. 7A and B illustrate zeptoliter (1 zeptoliter=10⁻¹² liters) reactors for nanodevice fabrication and integration. FIG. 7A is a side view of a chemically-modified nanopore, before and after the voltage-controlled synthesis of a nanoparticle (such as CdS quantum dot) in the nanopore volume. FIG. 7B is a top view of a membrane onto which nanoparticles can be integrated by precise positioning of the nanopore (in this case, between two electrodes) prior to nanoparticle fabrication.

The nanopore provides advantages in the described method because it increases the effective concentration of the ions that will form the nanoparticle inside the pore, thus driving the kinetics of the reaction towards nanoparticle formation. In addition, the nanopore limits the size of the particle that is formed to the nanoscale range. As discussed above, it is desirable to limit the nanoparticle size for many nanoparticle applications. Using the described methods, the size of the nanopore generally restricts the size of the nanoparticle that is formed. Accordingly, the size of the nanopores can be adjusted to the size of the nanoparticles that is to be fabricated. Typically, the nanoparticle size is between 1-100 nm. The shape of the nanoparticle can also vary. The shape and size of the nanopore can be adjusted to the size and shape of the nanoparticle that is to be fabricated.

For example, cadmium sulfide (CdS) nanoparticles, often referred to as quantum dots (QDs), are highly fluorescent particles at visible wavelengths, for which the emission is tunable by controlling the nanoparticle size. Due to its insolubility, CdS crystals form spontaneously upon mixing Cd²⁺ and S²⁻ salts. Using chemically-modified nanopores of various sizes, the two ions in the nanopore reaction volume are mixed, generating nanoparticles of various sizes.

In some embodiments, the nanopore is chemically coated with a chemical group (e.g., thiol group, a silyl group and the like) to assist in immobilizing the nanoparticle (such as a quantum dot) at the nanopore by chemically binding to the nanoparticle. In similar fashion, a variety of nanoparticles can be produced, including metallic, semiconducting, and insulating materials, with sub-nanometer size control, using the describe two-component mixing methods.

The position of the nanoparticle(s) can be precisely controlled on the membrane by drilling nanopores at specific locations, which can be easily performed by moving the electron beam to the desired coordinated on the membrane.

Exemplary nanoparticles that can be produced by this method include, but are not limited to, quantum dots. Examples of such quantum dots include, but are not limited to, CdSe, CdTe, PbS, PbSe, ZnS, ZnSe, ZnTe, HgS, HgSe, HgTe, GaN, GaP, GaAs, AlN, InAs, InP, InN, AlAs and SbTe.

Additional non-limiting examples of nanoparticles that can be produced by this method include, but are not limited to, metal particles such as Au, Ag, Pt, Pd and the like.

A person of skill in the art will be able to select the appropriate salt of the cation and anion (i.e., a first reagent and a second reagent) that will form the desired nanoparticle. Accordingly, this process can be extended to the manufacture of many different nanoparticles, where the only difference is that the appropriate chemical component is added to each of the electrolyte chambers.

Exemplary electrolytes that can be used in the fabrication process include, but are not limited to, KCl, NaCl, NaNO₃, NaSO₄, as well as other salts. The concentration range of the electrolyte in the electrolyte chamber is typically between about 10 mM to about 1M.

After the nanoparticles are formed, they can be released from the nanopore and used in other applications. Such release can be a simple as a washing the nanoparticle from the nanopore. Chemical coating of the nanopore prior to nanoparticle formation with “non-stick” groups (e.g., with thiol groups, amine groups, phosphine groups, silyl groups and the like) can facilitate the removal of nanoparticles.

Non-stick groups such as non-stick silanes can be added to the membrane surface to prevent the clogging of the pore and to release the nanoparticles from the membrane for synthesis. For this purpose, a PEG-silane or other hydrocarbon-containing silanes can be used, such as an aminosilane coupled to a PEG-succinimidyl ester of any molecular weight.

Some nanoparticles, e.g., quantum dots, have fluorescence properties and can be used in for imaging purposes. Examples include labeling biological molecules inside cells (e.g., antibodies can be bound to quantum dots). Quantum dots with specific coatings can be used to target biological molecules, such as nucleic acids. Their fluorescence properties allow quantum dots to be used for FRET (Fluorescence Resonance Energy Transfer) detection, imaging and localization of single molecules.

Quantum dots made by the herein described methods can provide precise control over the quantum dot size. Quantum dot size is important for improving their solubility and biological tissue permeability, particularly for quantum dots that are used as biological labels.

Embodiments of the invention is further illustrated by the following examples, which should not be construed as limiting. Those skilled in the art will recognize, or be able to ascertain, using no more than routine experimentation, numerous equivalents to the specific substances and procedures described herein. Such equivalents are intended to be encompassed in the scope of the claims that follow the examples below.

### EXAMPLES

### Example 1

### Preparation of CdS Particles

In a typical experiment, a 5-10 nm pore or an array of pores is assembled between two chambers of electrolyte (e.g., 100 mM to 1 M KCl). Following assembly of the pore, a different reagent is added to each of the two chambers. An example is given here for the preparation of cadmium sulfide nanoparticles (CdS). A probing voltage in the range −1 to 1 V is applied across the nanopore using a pair of electrodes, in order to measure the electrolyte current through the pore. Then, a 1-100 mM solution of any Cd²⁺ salt (e.g., CdCl₂, CdSO₄, and any other water-soluble Cd²⁺ salt) is added to the top chamber, whereas a 100 mM solution of a water-soluble S²⁻ salt (e.g., Na₂S, K₂S, (NH₄)₂S) is added to the bottom chamber while voltage is applied. The current through the pore is monitored during the deposition process. A gradual drop in the current occurs within seconds to minutes from an open state to a closed, marking the formation of a particle. Following the deposition, the solutions on both sides of the membrane are thoroughly washed, leaving behind the deposited particle in the pore position. The particle is then imaged using the TEM (Transmission Electron Microscopy) and characterized using optical techniques (e.g., fluorescence).

This process can be extended to fabricate a variety of nanoparticles, by altering the reagents such as salts that added to the chambers.

### REFERENCES

The following citations are referenced in the application, the contents of which are herein incorporated by said reference in their entirety:
(1) a) Kasianowicz, J. J.; Brandin, E.; Branton, D.; Deamer, D. W. Proc. Natl. Acad. Sci. U.S.A. 1996, 93, 13770-13773. b) Akeson, M.; Branton, D.; Kasianowicz, J. J.; Brandin, E.; Deamer, D. W. Biophys. J. 1999, 77, 3227-3233. c) Meller, A.; Nivon, L.; Brandin, E.; Golovchenko, J.; Branton, D. Proc. Natl. Acad. Sci. U.S.A. 2000, 97, 1079-1084. d) Meller, A.; Nivon, L.; Branton, D. Phys. Rev. Lett. 2001, 86, 3435-38. e) Sauer-Budge, A. F.; Nyamwanda, J. A.; Lubensky, D. K.; Branton, D. Phys. Rev. Lett. 2003, 90, 238101. f) Mathe, J.; Visram, H.; Viasnoff, V.; Rabin, Y.; Meller, A. Biophys. J. 2004, 87, 3205-3212. g) Mathe, J.; Aksimentiev, A.; Nelson, D. R.; Schulten, K.; Meller, A. Proc. Natl. Acad. Sci. U.S.A. 2005, 102, 12377-82. h) Butler, T. Z.; Gundlach, J. H.; Troll, M. A. Biophys. J. 2006, 90, 190-199. i) Stefureac, R.; Long, Y. T.; Kraatz, H. B.; Howard, P.; Lee, J. S. Biochemistry 2006, 45, 9172-9179. j) Hornlower, B.; Coombs, A.; Whitaker, R. D.; Kolomeisky, A.; Picone, S. J.; Meller, A.; Akeson, M. Nat. Meth., 2007, 4:315-7;
(2) Meller, A. J. Phys. Cond. Mat. 2003, 15, R581-R607;
(3) a) Bayley, H.; Cremer, P. Nature 2001, 413, 226-230. b) Braha, O.; Gu, L. Q.; Zhou, L.; Lu, X.; Cheley, S.; Bayley, H. Nat. Biotech. 2000, 18, 1005-1007. c) Gu, L. Q.; Braha, O.; Conlan, S.; Cheley, S.; Bayley, H. Nature 1999, 398, 686-690. d) Howorka, S.; Cheley, S.; Bayley, H. Nat. Biotech. 2001, 19, 636-639. e) Cheley, S.; Gu, L. Q.; Bayley, H. Chem. Bio. 2002, 9, 829-838. f) Merzlyak, P. G.; Capistrano, M. F. P.; Valeva, A.; Kasianowicz, J. J.; Krasilnikov, O. V. Biophys. J. 2005, 89, 3059-3070. g) Kang, X. F.; Cheley, S.; Guan, X. Y.; Bayley, H. J. Am. Chem. Soc. 2006, 128, 10684-10685;
(4) Lev, A. A.; Korchev, Y. E.; Rostovtseva, T. K.; Bashford, C. L.; Edmonds, D. T.; Pasternak, C. A. Proc. R. Soc. Lond. B 1993, 252, 187-192;
(5) a) Sun, L.; Crooks, R. M. J. Am. Chem. Soc. 2000, 122, 12340-12345. b) Apel, P. Y.; Korchev, Y. E.; Siwy, Z.; Spohr, R.; Yoshida, M. Nuc. Inst. Met. B 2001, 184, 337-346. c) Harrell, C. C.; Siwy, Z. S.; Martin, C. R. Small 2006, 2, 194-198. d) Wu, S. S.; Park, S. R.; Ling, X. S, Nano Let. 2006, 6, 2571-2576;
(6) a) Shao, Y. H.; Mirkin, M. V. J. Am. Chem. Soc. 1997, 119, 8103-8104. b) Zhang, B.; Zhang, Y. H.; White, H. S. Anal. Chem. 2004, 76, 6229-6238. c) Umehara, S.; Pourmand, N.; Webb, C. D.; Davis, R. W.; Yasuda, K.; Karhanek, M. Nano Let. 2006, 6, 2486-2492;
(7) Li, J.; Stein, D.; McMullan, C.; Branton, D.; Aziz, M. J.; Golovchenko, J. A. Nature 2001, 412, 166-169;
(8) Storm, A. J.; Chen, J. H.; Ling, X. S.; Zandbergen, H. W.; Dekker, C. Nat. Mater. 2003, 2, 537-540;
(9) Wu, M. Y.; Krapf, D.; Zandbergen, M.; Zandbergen, H.; Batson, P. E. Appl. Phys. Let. 2005, 87, 113106;
(10) Kim, M. J.; Wanunu, M.; Bell, D.C.; Meller, A. Adv. Mater. 2006, 18, 3149-3153;
(11) Heng, J. B.; Ho, C.; Kim, T.; Timp, R.; Aksimentiev, A.; Grinkova, Y. V.; Sligar, S.; Schulten, K.; Timp, G. Biophys. J. 2004, 87, 2905-2911;
(12) Fologea, D.; Gershow, M.; Ledden, B.; McNabb, D. S.; Golovchenko, J. A.; Li, J. L. Nano Let. 2005, 5, 1905-1909;
(13) Storm, A. J.; Chen, J. H.; Zandbergen, H. W.; Dekker, C. Phys. Rev. E 2005, 71, 051903;
(14) a) Siwy, Z. S.; Powell, M. R.; Petrov, A.; Kalman, E.; Trautmann, C.; Eisenberg, R. S. Nano Let. 2006, 6, 1729-1734. b) Siwy, Z.; Kosinska, I. D.; Fulinski, A.; Martin, C. R. Phys. Rev. Lett. 2005, 94, 048102;
(15) a) Heins, E. A.; Baker, L. A.; Siwy, Z. S.; Mota, M.; Martin, C. R. J. Phys. Chem. B 2005, 109, 18400-18407. b) Heins, E. A.; Siwy, Z. S.; Baker, L. A.; Martin, C. R. Nano Let. 2005, 5, 1824-1829;
(16) Siwy, Z.; Trofin, L.; Kohli, P.; Baker, L. A.; Trautmann, C.; Martin, C. R. J. Am. Chem. Soc. 2005, 127, 5000-5001;
(17) Han, A. P.; Schurmann, G.; Mondin, G.; Bitterli, R. A.; Hegelbach, N. G.; de Rooij, N. F.; Staufer, U. Appl. Phys. Let. 2006, 88, 093901;
(18) Mitsui, T.; Stein, D.; Kim, Y. R.; Hoogerheide, D.; Golovchenko, J. A. Phys. Rev. Lett. 2006, 96, 036102;
(19) a) Harrell, C. C.; Lee, S. B.; Martin, C. R. Anal. Chem. 2003, 75, 6861-6867. b) Polk, B. J.; Bernard, M.; Kasianowicz, J. J.; Misakian, M.; Gaitan, M. J. Electro. Soc. 2004, 151, C559-0566;
(20) a) Chen, P.; Mitsui, T.; Farmer, D. B.; Golovchenko, J.; Gordon, R. G.; Branton, D. Nano Let. 2004, 4, 1333-1337. b) Danelon, C.; Santschi, C.; Brugger, J.; Vogel, H. Langmuir 2006, 22, 10711-10715;
(21) Nilsson, J.; Lee, J. R. I.; Ratto, T. V.; Letant, S. E. Adv. Mater. 2006, 18, 427-431;
(22) Wang, G. L.; Zhang, B.; Wayment, J. R.; Harris, J. M.; White, H. S. J. Am. Chem. Soc. 2006, 128, 7679-7686;
(23) a) Giridhar, R. V.; Rose, K. J. Electro. Soc. 1988, 135, 2803-2807. b) Yanez, J. A.; Baretzky, B.; Wagner, M.; Sigmund, W. M. J. Eur. Cer. Soc. 1998, 18, 1493-1502. c) Waltman, R. J.; Yen, B. K.; White, R. L.; Pocker, D. J. Chem. Mater. 2004, 16, 4878-4889. d) Wu, P.; Hogrebe, P.; Grainger, D. W. Biosens. Bioelec. 2006, 21, 1252-1263;
(24) Netzer, L.; Sagiv, J. J. Am. Chem. Soc. 1983, 105, 674-676;
(25) The effective film thickness, calculated from attenuation of the substrate signals, is consistent with the thickness measured by ellipsometry;
(26) http://srdata.nist.gov/xps;
(27) Egerton, R. F.; Li, P.; Malac, M. Micron 2004, 35, 399-409;
(28) a) Williams, R. A.; Blanch, H. W. Biosens. Bioelec. 1994, 9, 159-167. b) Rozkiewicz, D. I.; Kraan, Y.; Werten, M. W. T.; de Wolf, F. A.; Subramaniam, V.; Ravoo, B. J.; Reinhoudt, D. N. Chem. Eur. J. 2006, 12, 6290-6297;
(29) Stein, D.; Kruithof, M.; Dekker, C. Phys. Rev. Lett. 2004, 93, 035901;
(30) a) Schiedt, B.; Healy, K.; Morrison, A. P.; Neumann, R.; Siwy, Z. Nuc. Inst. Met. B 2005, 236, 109-116. a) Daiguji, H.; Yang, P. D.; Majumdar, A. Nano Let. 2004, 4, 137-142. b) Ramirez, P.; Aguilella-Arzo, M.; Alcaraz, A.; Cervera, J.; Aguilella, V. M. Cell Biochem. Biophys. 2006, 44, 287-312;
(31) a) Kakiuchi, T.; Iida, M.; Imabayashi, S.; Niki, K. Langmuir 2000, 16, 5397-5401. b) Nishiyama, K.; Kubo, A.; Ueda, A.; Taniguchi, I. Chem. Let. 2002, 80-81;
(32) Wang, A. F.; Tang, H. Y.; Cao, T.; Salley, S. O.; Ng, K. Y. S. J. Coll. Int. Sci. 2005, 291, 438-447.

We claim:

1. A method for manufacturing a nanoparticle comprising:
(a) providing a solid state nanopore having a first chamber and a second chamber, each chamber comprising an electrolyte solution;
(b) adding a first reagent to the first chamber of the nanopore;
(c) adding a second reagent to the second chamber of the nanopore;
(d) applying a first voltage to the nanopore,
such that the first voltage drives formation of a nanoparticle inside the nanopore, wherein the nanoparticle comprises a cation of the first reagent forming an ionic bond with an anion of the second reagent.

2. The method of claim 1, further comprising monitoring the current flow through the nanopore before or during the nanoparticle formation.

3. The method of claim 1, wherein a drop in current indicates formation of the nanoparticle.

4. The method of claim 1, wherein the nanoparticle is insoluble in water.

5. The method of claim 1, wherein the nanoparticle is a quantum dot.

6. The method of claim 5, wherein the quantum dot comprises a compound selected from the group consisting of CdS, CdSe, CdTe, PbS, PbSe, ZnS, ZnSe, ZnTe, HgS, HgSe, HgTe, GaN, GaP, GaAs, AlN, InAs, InP, InN, AlAs and SbTe.

7. The method of claim 5, wherein the cation of the first reagent is selected from the group consisting of Cd²⁺, In³⁺, Pb²⁺, Zn²⁺, Hg²⁺, Ga³⁺, Al³⁺ and Sb²⁺.

8. The method of claim 5, wherein the anion of the second reagent is selected from the group consisting of S²⁻, Se²⁻, As³⁻, P³⁻, Te²⁻, N³⁻ and As³⁻.

9. The method of claim 6, wherein the compound comprises CdS.

10. The method of claim 1, wherein the cation of the first reagent is selected from the group consisting of Cd²⁺, In³⁺, Pb²⁺, Zn²⁺, Hg²⁺, Ga³⁺, Al³⁺ and Sb²⁺.

11. The method of claim 1, wherein the anion of the second reagent is selected from the group consisting of S²⁻, Se²⁻, As³⁻, P³⁻, Te²⁻, N³⁻ and As³⁻.

12. The method of claim 1, wherein the solid state nanopore is chemically modified.

13. The method of claim 12, wherein the solid state nanopore is chemically modified with a thiol group, a silyl group, an amine group, a phosphine group.

14. The method of claim 12, wherein the solid state nanopore is coated with a PEG-silane or a hydrocarbon-containing silane.

15. The method of claim 14, wherein the PEG silane is aminosilane coupled to a PEG-succinimidyl ester.

16. The method of claim 1, wherein the electrolyte is KCl or NaCl.
